(19) United States
(12) Patent Application Publication
(10) Pub. No.: US 2026/0270270 A1
(43) Pub. Date: Sep. 10, 2026

(54) Multiple User Data Pool with End-to-End Encryption

(71) Applicant: Joshua Joseph Boutwell, Frederick, MD (US)

(72) Inventor: Joshua Joseph Boutwell, Frederick, MD (US)

(21) Appl. No.: 19/167,313

(22) PCT Filed: Mar. 19, 2024
(86) PCT No.: PCT/US2024/020609

§ 371 Date: Sep. 19, 2025

Related U.S. Application Data
(60) Provisional application No. 63/453,153, filed on Mar. 19, 2023.

(51) Int. Cl. H04L 9/40

(52) U.S. Cl. CPC H04L 63/104; H04L 63/0428

(57) ABSTRACT

Methods and a system for a multiple user database with secure end-to-end encryption which uses, at minimum, two different types of data structures to allow multiple users to access and update the system while maintaining data integrity across the shared data pool. The multiple user database uses standard data packages, which contain the database data, and locking packages associated with the standard data packages which serve to track changes and allow a user to confirm the local copy of the data pool is consistent with the shared data pool. The shared data pool may operate within a fully encrypted environment and the data pool server may be ignorant of the data stored within the shared data pool.

### CROSS REFERENCE TO RELATED APPLICATIONS

The present application claims priority under 35 U.S.C. § 119(e) from U.S. Provisional Application Ser. No. 63/453,153, filed Mar. 19, 2023, entitled “Multiple User Database in End-To-End Environment,” and U.S. application Ser. No. 18/597,906, filed Mar. 6, 2024, entitled “Multiple User Database with End-to-End Encryption,” the disclosures of which are hereby incorporated by reference herein in their entirety.

### FIELD OF THE INVENTION

The present invention relates generally to the field of databases. More specifically, the invention is in the subfield of multiple user databases with encryption.

### BACKGROUND OF THE INVENTION

Databases are frequently used to allow multiple users to share and modify data, such as computer files, electronic documents, or other electronically stored information. Databases that may be used by multiple users simultaneously often require complex data checking systems that are error prone and require large amounts of bandwidth. These systems require large amounts of power and computer processing resources. Despite the intensive use of resources, existing database systems often lose data integrity and do not function well in end-to-end encrypted environments, or they may sacrifice security to allow for easier workflow and distribution of data to multiple users.

### SUMMARY OF THE INVENTION

An aspect of an embodiment of the present invention provides for a secured data pool shared by multiple parties with end-to-end encryption. The secured data pool is fully encrypted, and the data server is ignorant of the secured data that is shared by users. The secured data pool uses data packages, which are divided into standard packages and corresponding locking packages to distribute and track data shared by multiple users. Each of the data packages include checksums that allow the system to compare local copies of data to the data stored on the central server without requiring access or knowledge of the data stored within the data packages. The locking packages record a history of changes to the standard packages by maintaining a listing of checksum changes over time. The system may then monitor changes to the data packages by monitoring changes to the checksums, which are recorded in the locking packages. Implementation of simple logic in the secured data pool can then be used to manage the data and ensure data integrity with minimal use of bandwidth and without the need to reveal encrypted data to the main data server.

The shared data pool may comprise a system with a number of parts that provide the functionality of storing, serving, and error-proofing a shared dataset that is encrypted and intended to be accessed and updated by a number of different users.

### DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 provides a block diagram of an exemplary embodiment of a multiple user data pool.

FIG. 2 provides a schematic depiction of an exemplary embodiment of a standard data package data structure in a multiple user data pool.

FIG. 3 provides a schematic depiction of an exemplary embodiment of a locking package data structure in a multiple user data pool.

FIG. 4 provides a flowchart of an exemplary embodiment of a method for setting up or establishing a multiple user data pool.

FIG. 5 provides a flowchart of an exemplary embodiment of a method for creating data in a multiple user data pool.

FIG. 6 provides a flowchart of an exemplary embodiment of a method for creating data in a multiple user pool.

FIG. 7 provides a flowchart of an exemplary embodiment of a method for distributing data across a multiple user data pool when multiple users have requested data.

### DETAILED DESCRIPTION OF EXEMPLARY EMBODIMENTS OF THE INVENTION

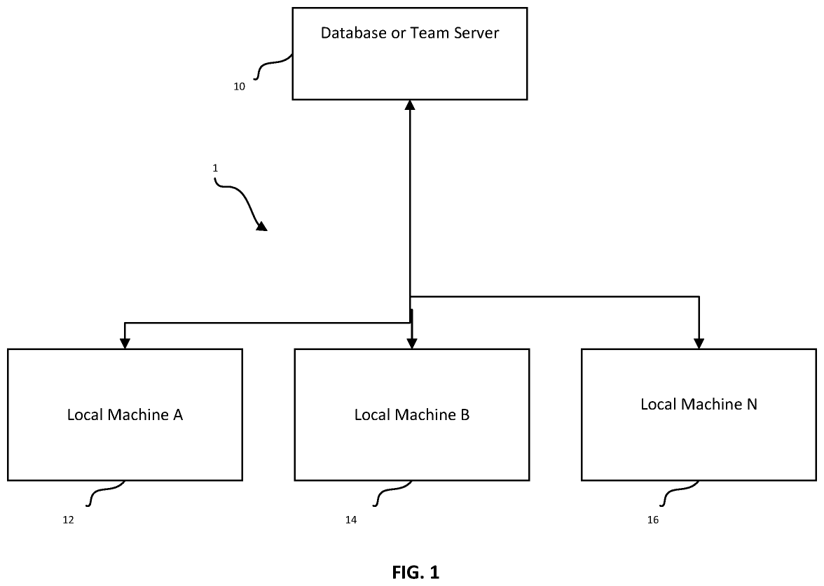

FIG. 1 provides a block diagram of an exemplary embodiment of the structure of a shared or multiple user data pool 1 with end-to-end encryption. The multiple user data pool 1 may comprise one or more database or team servers 10 in electronic communication with a first local machine A 12, a second local machine B 14, and a third local machine N 16. It should be appreciated that the multiple user data pool 1 may comprise any number of local machines distributed in multiple locations. Similarly, the multiple user data pool 1 may comprise multiple database or team servers 10, and the functions of the multiple user data pool 1 may be distributed amongst multiple servers or multiple local machines in any manner as required by a particular application or implementation of the multiple user data pool 1. It should be appreciated that the database or team server 10, or any local machine 12, 14, 16 or any other electronic devices connected to or within the personal data pool may comprise any type of electronic device including, but not limited to, computers, servers, cellular phones, smart phones, tablets, or other devices which may connect to and communicate through the internet or other electronic means.

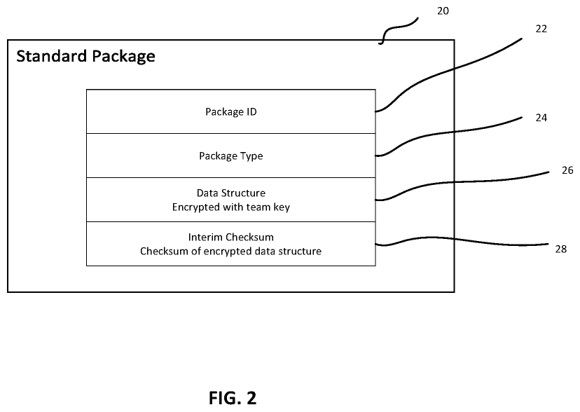

FIG. 2 provides a schematic depiction of an exemplary embodiment of a standard data package 20 data structure for use in a multiple user shared data pool. The standard data package 20 may include a number of standard data fields including the data package ID 22, which identifies the data package in the shared data pool, a field for package type 24, in this case a standard type data package. The standard data package 20 may also include a field for storing the encrypted data 26 of the standard data package 20, and a field to record the checksum of the encrypted data 28. It should be appreciated that in certain embodiments, the standard data package 20 may include any number of additional optional fields that may be desired or required in particular implementation of the shared data pool. For example, the standard data package 20 may also include a field for an electronic signature or other user identification to maintain a record of a person or machine that has manipulated or otherwise changed the data contained within the standard data package 20.

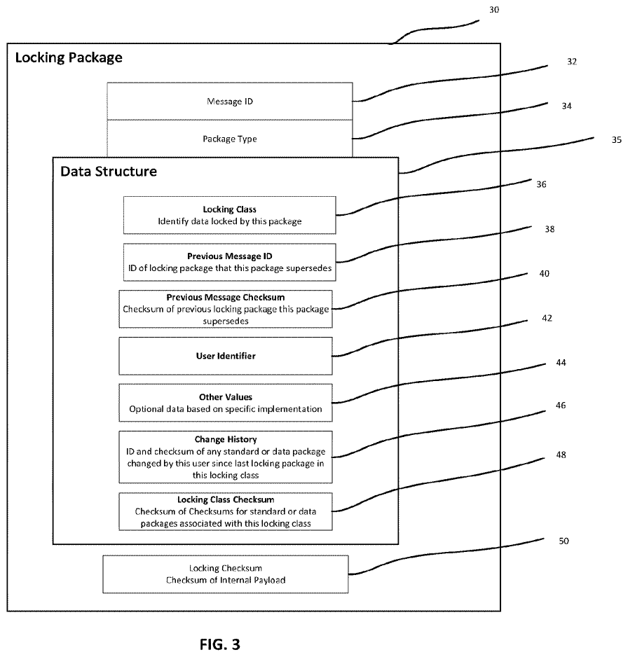

FIG. 3 provides a schematic depiction of an exemplary embodiment of a locking package 30 data structure for use in a multiple user shared data pool. The locking package 30 may include any number of data fields or structures. For example, the locking package 30 may include a message ID 32 which identifies the unique locking package on the shared data pool, and a field for package type 34, in this case a locking package type. The locking package 30 may also include a locking class 36, which defines the type of data or data packages the locking package 30 tracks or is associated with, a previous message ID 38, which records the message ID of the locking package 30 that precedes the current locking package 30. Similarly, the locking package 30 may also include the previous message checksum 40, which records the checksum of the locking package 30 that precedes the current locking package 30, and a field to record the user identity 42 of the user that created the locking package 30. The locking package 30 may also include a change history 46, which records the package ID for every standard data package and the corresponding checksum for every standard data package that is associated with the locking class 36 of this locking package 30. The locking package 30 may also include a locking class checksum 48, which is the checksum of checksums for all of the standard data packages associated with this locking class 36. Finally, the locking package may include a locking checksum 50, which is the checksum of the internal payload of the data structure 35, and an optional data field 44 for recording any other data as desired or required for a particular implementation of the multiple user shared data pool. It should be appreciated that in certain embodiments, the fields within the data structure 35, such as the locking class 36, previous message ID 38, previous message checksum 40, user identifier 42, other values 44, change history 46, and locking class 48 may be encrypted while the message ID 32, package type 34, and locking checksum 50 may be unencrypted data.

Referring to FIGS. 2 and 3, the use of standard or data packages 20 in conjunction with locking packages 30 facilitates a serverless, asynchronous multi-user database. The database is serverless in that the server itself need not perform any function besides storing and serving of the standard packages 20 and locking packages 30 and does not require any kind of access or knowledge of the specific data contained within the data pool nor does the server need to perform any additional functions or editing of the data contained within the data pool.

On the initial creation of the shared data pool, the server may receive one or more standard or data packages 20 that are associated with a particular category or class of data, and a locking package 30 that is associated with and tracks changes to that category or class or data and all the standard packages 20 contained therein. This initial locking package 30, or a locking package 30 created by a user able to edit or delete locking packages 30 after the resolution of a data conflict, may record the package ID and checksum for every standard package 20 in the data category in the change history 46 field. Subsequent versions of the locking package 30 in this locking class may only include the package ID and checksum for standard packages 20 which have changed or been updated, plus a reference to the previous locking package 30 version in the chain in the previous message ID 38. In this way, the chain of locking packages 30 may record all of the changes to any standard packages 20 within the locking class. It should be appreciated that this data category is recorded in the locking class 36 field of the locking package 30.

Still referring to FIGS. 2 and 3, when a user on a local machine logs in to the database, the local machine may compare its local listing of all package IDs and all package checksums for both standard packages 20 and locking packages 30 to the listing provided by the server. If there are any package IDs missing from the local list, or any package IDs that do not have matching checksums, the local machine may then download these package IDs from the server and decrypt them on the local machine. One of the downloaded packages from the server will be an updated locking package 30. The local machine may then compare the newly downloaded standard packages 20 to the change history 46 field of the newly downloaded locking package 30 to verify that all of the package IDs listed within the change history 46 field are represented in the newly downloaded standard packages 20 and that the checksums of the newly downloaded standard packages 20 match the listed checksums in the change history 46 field. If all package IDs and checksums for the newly downloaded standard packages 20 match the listing of the change history 46, then the local machine has verified that the database is complete and up to date. If, however, there are discrepancies between the newly downloaded standard packages 20, or if the change history lists additional package IDs which were not obtained from the server, the local machine, and subsequently the user, may be notified of a potential data issue or conflict. Once a conflict has been identified, the payload software, which may be built on top of the shared data pool, may then carry out defined procedures to resolve the data conflict, or request the input of a user to resolve the conflict. It should be appreciated that the resolution of the conflict may be determined by this payload software, and may be defined or applied as necessary for the particular implementation or requirements of the payload software.

Still referring to FIGS. 2 and 3, the shared data pool may also use the locking packages 30 to identify data conflicts from multiple users editing shared data pool data concurrently and flag these for a user or any applicable payload software to resolve. For example, if two users on two local machines are editing or updating data within the same locking class, each local machine will generate and upload a new locking package 30 to the server with a record of the changes made on that local machine in the change history 46, a user identifier 42, and the previous version of the locking package for this class or category of data in the previous message ID 38. On a subsequent check by any user of their local copy of the shared data pool and the server copy of the shared data pool, both of the updated locking packages 30 will be downloaded to the local machine and decrypted. The local machine may then determine that there are two locking packages 30 which contain the same previous message ID 38, indicating a conflict or fork in the locking package 30 chain. The local machine may then check the change history 46 of each forked locking package 30 since the last consistent locking package 30 to determine if the forked locking packages 30 have applied changes to the same standard packages 20. If the forked locking packages 30 do not apply changes to the same standard packages 20, then there is no data conflict and the data pool may be brought up to a consistent state with all changes present. If, however, the forked locking packages 30 both list changes to the same standard packages 20 in the change history 46, then the shared data pool may flag this to notify the payload software or a user of the data conflict or collision and the need to resolve the conflict before the shared data pool may be brought to a consistent state for all users.

It should be appreciated that any method for resolving data conflicts or collisions, including, but not limited to, time of changes, type of changes, preference for one user's changes over another, or any other method of rectifying a data conflict or collision may be implemented. The determination of what type of data conflict resolution is appropriate may be made by the payload software built on top of the shared data pool, a user with appropriate permission to resolve the conflict, or any other factors as desired or required for a particular implementation of the shared data pool.

In further reference to FIGS. 2 and 3, the shared data pool may use a tiered system of locking packages 30 to provide additional options and methods for tracking changes to the standard packages 20 and the data contained therein. For example, when the shared data pool data is divided into data classes or categories, additional super classes or categories of data may be defined in the implementation. In certain embodiments, the data may be divided into multiple categories or classes, each with its own respective set of one or more standard packages 20 and a corresponding locking package 30. A super class may then be defined which includes data from multiple classes (herein referred to as sub-classes when included within a super class), data from sub-classes and additional data that does not fall into another class, or any combination thereof. In certain embodiments, a super class may be defined to include all data within the multiple user data pool, or any subset of data contained therein. This super class may then be assigned a locking package 30 to track changes to any of the data within that super class.

The locking package 30 for an associated super class may then function in a manner similar to any other locking package 30 which is associated with a standard data class or sub-class as described above. However, the change history 46 of a locking package 30 for a super class may include a listing of only standard package 20 IDs and checksums, only locking package 30 IDs and checksums for the locking packages 30 associated with the sub-classes or categories of data contained within the super class, or both standard package 20 IDs and checksums and locking package 30 IDs and checksums for the sub-classes or categories of data contained within the super class. It should be appreciated that the change history 46 may also contain combinations of these listings. For example, the change history 46 for a locking package 30 associated with a super class may include standard package 20 IDs and checksums for data which is not associated with a sub-class or category of data, and then it may also include locking package 30 IDs and checksums to represent the data within standard packages 20 that are associated with a sub-class or category of data. If the change history 46 of the locking package 30 for a super class does not include all standard package 20 IDs and checksums for an associated sub-class, that information is still recorded within the locking package 30 for the sub-class and may still be tracked with reference to individual standard packages 20. A change to a particular standard package 20 in a sub-class will cause a change to the locking package 30 of that sub-class, which then will be recorded in the change history 46 of the locking package 30 for the super class. It should be appreciated that this layered classification of data and the associated locking packages 30 may be implemented to any number of layers or any number of super classes to allow for monitoring of data within the shared data pool to any level of specificity as necessary for a particular implementation or payload software. Furthermore, the layered classification of data allows the shared data pool to notify or flag conflicts or collisions of data at any level of data categorization or classification, or at multiple levels of data categorization or classification to allow for flagging of data collisions or conflicts to a lesser or greater degree. For example, the shared data pool may flag a data conflict at different levels with different priority, or only flag data at a specific level of classification to allow payload software or a user to more efficiently resolve data conflicts or to ignore low priority data conflicts during use of the shared data pool.

The initiation of the shared data pool may begin with the setup of a team, which is the listing of all the users that are intended to access, update, or modify the data held within the shared data pool. The team may be split into a number of classes of users, each of which may be given different permissions in how they may modify or update the data on the shared data pool, what data they are given access to, and how they may modify the different data packages in the shared data pool that define the data and the change history of that data. For example, the team may include standard users who are given permissions to allow them to create, read, update, and delete standard packages on the shared data pool. They may also be given permission to create or read locking packages (described below), which are packages in the shared data pool that maintain a record of the changes made to the standard packages in the shared data pool. However, they may not be given permission to update or delete the locking packages that record the change history of the standard packages. By contrast, certain members of the team may be designated as super users who have all the permissions available to the standard user, but who may also update or delete the locking packages in the shared data pool. It should be appreciated that the team may include any number of users, and that there may be any number of classes with permissions defined as desired or required for a particular workflow or functionality for the members of the team.

The shared data pool also must include at least two types of data packages that are stored and which define the data and the change history of the dataset contained within the shared data pool. All data packages on the shared data pool must include a unique package ID, a field for defining the class of that data package, the data contained within that package, and a checksum used to verify data integrity. These different fields and additional optional fields are described with more particularity below. It should be appreciated that data packages may be relatively small, on the order of one megabyte or less, but any size of data packages may be supported by the shared data pool.

The first of these types of data packages may be a standard package. A standard package holds the encrypted data that the team wishes to share across the shared data pool. A standard package must contain at least four different types of information within it, though additional fields or types of information may be included in a standard data package as necessary for a particular implementation of the shared data pool. First, each standard package must include a package ID that is unique to that particular package on the shared data pool. These package IDs may be generated using a global unique identifier (GUID) or a universal unique identifier (UUID). However, any mechanism for providing unique package IDs to all packages on the system may be used to assign package IDs. The standard package must also include a field which defines it as a standard package (as opposed to a locking package or other type of package). The standard package will also hold the data, such as documents, images, spreadsheets, or any other data that is to be stored on the shared data pool, and a checksum that is determined from the data held within the standard package. The checksum of the standard data package (and all data packages) must be one that is deterministically derived from the data that is held within the standard data package. The checksum is not required to be cryptographically valid. Any method for determining the checksum of the encrypted data of the data package may be used, and a number of standard checksum functions are currently available and may be implemented. The choice of checksum may be arbitrary, but it should be long enough such that the chances of two data packages within the shared data pool having identical checksums is below some level of tolerance for the implementation of the shared data pool. It should be appreciated that the checksum of the data package is a checksum calculated from the data after it is encrypted within the data package. In such an embodiment, a server or other computer may calculate the checksum of the encrypted data for tracking of the data package without the need for access to any encryption key or encrypted data held within the data package.

The shared data pool may also include a second type of data packages that monitors the change history of the data that is stored on the shared data pool. This package type, which may be referred to as a locking package, tracks what data packages have been updated and how their checksums have changed. Locking packages are created by a user after completion of an activity that changes the data within the shared data pool and are always uploaded with the updated standard package containing the updated data. The locking package records the checksum of the newly edited standard package, and also records the package ID and checksum of the previous locking package associated with that standard package, allowing the system to affirmatively verify data integrity. Using this record of changes and the chain of locking packages, their IDs, and checksums, the system can then identify the order of the locking packages without the need for the system to have any access to the data stored in the standard packages for this verification. The locking packages may also include cryptographic signatures that include what user made the changes to the data stored in the standard package, which may then be used to determine if the user making changes was authorized to make changes to the data contained within the standard package.

The locking packages may include the four mandatory fields of data described above, and one or more additional fields of data. For example, the locking packages may include a field to define a locking class or category. The locking class or category defines a class of locking packages for a particular type, grouping, or category of data, such as data associated with a specific client, originating in a particular timeframe, or by any other definition as set by a user of the shared data pool. It should be appreciated that a single standard package may be listed in multiple locking classes or categories. A field for the locking class or category checksum may also be implemented in the locking package data. The locking class or category checksum records the checksum of checksums for all standard packages that fall within the criteria set for the locking class or category. It should be appreciated that in certain embodiments the locking packages may also include fields that record the checksum of checksums for the locking packages, or for both the locking packages and standard packages that fall within the criteria of the locking class or for the entire dataset.

The locking package may also include a field for previous package IDs or previous message IDs. The previous package IDs retain a listing of the specific locking packages that were previously associated with the standard package. It should be appreciated that there may be multiple previous package IDs corresponding to multiple previous locking packages in the case of a locking package that is used to merge a fork in the data stream of the standard package. In the case of a locking package being the first locking package associated with a standard package, either because the standard package was newly created or at the implementation of the shared data pool, the previous package ID may be set by the system. The locking package may also include a field for storing the checksums of the previous locking packages or previous message checksums in the chain of locking packages. Each previous locking package checksum may be associated with the package ID of the corresponding locking package ID. In the case of a locking package that is the first locking package in the chain, the previous package checksum or previous message checksum field may be set to empty, zero, null, or some other placeholder determined by the system.

A field for change history may also be included within the locking packages. The change history is a list of all package IDs and associated checksums that were altered by the user during the process that has caused the creation of the new locking package. For instance, if the user is updating data in the system that is associated with multiple standard packages, the package ID and checksum for each standard package that was updated during the event will be included in the change history stored within the locking package. In the case of a standard package that is deleted, the system may set the checksum value for a deleted standard package to empty, zero, null, or some other specified value.

The locking package may also optionally include a field for the user ID of the user that created the locking package. This field allows a user to cryptographically sign the locking package using their private asymmetrical key. Another user that is downloading the locking package may then use the original user's public key to verify the authenticity of the package by using the signor's public key that is held in the public key repository on the central server of the shared data pool. Because these types of signature require a value to verify against, the system may use the locking class checksum as the value for the cryptographic signature. However, the system may be implemented to use other values for verifying the cryptographic signature of the user who created the locking package.

In certain embodiments, the data packages may include other classes of packages outside of standard packages and locking packages. Furthermore, any class of package may include one or more additional fields not described above for the implementation of a shared data pool for a specific purpose, workflow, or dataset as desired or required.

The shared data pool may also include a server that functions as a non-local repository of data that all team members have access to. The server primarily serves three functions in the shared data pool. First, the server functions as a package repository that holds all the packages for the dataset that is being used by the team. As part of this function as the package repository, the server may also provide a global list of all packages in the dataset and provide a global checksum of all the packages active in the dataset which may be used by a local user to verify the completeness of his or her local dataset. Second, the server may function as an authenticator that can verify the identity of all users, and which can verify the permissions that are allowed for standard users, super users, or any other class of user verified on the system. Thirdly, the server may also function as a repository for the public encryption keys for all users in the team and which is accessible by other users for verifying cryptographically signed data packages.

In certain embodiments, the server may also fulfill additional functionality to its three main functions, or it may provide additional features related to those three main functions. For example, the server may provide a list of all current data packages in the shared data pool, but may also limit the list of data packages shown to a particular user based on his or her permissions within the shared data pool. The server may also serve up or send out packages as requested by members of the team. In this capacity, the server may also authenticate that the user is allowed access to the requested data. The server may also retain historical packages that have been superseded by newer data packages and allow a user to request a historical package by package ID and checksum. It should be appreciated that the parameters for the server maintaining historical data packages may be set as desired or required for a particular application, but may be modified as needed to accommodate different hardware, storage limitations, or bandwidth limitations of the overall shared data pool system. As part of its authenticating role, the server may also restrict the ability of a user to create, update, and delete data packages based on the permissions that have been set for that particular user.

Because the server may be a repository of all packages that are currently active on the shared data pool, the server may also maintain and serve up a global checksum, which is the checksum of the checksums of all packages maintained on the shared data pool. It should be appreciated that where particular users are only allowed access to a subset of the complete dataset on the shared data pool, the server may also maintain a repository of global checksums for the particular user. A user may then query the server for a global checksum, which may then be compared to the global checksum of the local copy of the data, so that a user may verify whether they have a complete dataset, or whether their dataset is out of date and further modifications or updates to the dataset need to be downloaded to the local dataset. In certain embodiments, the server may also maintain timestamped global checksums allowing a user to verify that all packages are present on their local dataset at that time.

The server may also function to pause updates to the dataset. In certain embodiments, a specific user may request that the server disallow any updates or changes to specific data packages or types of packages. This may allow a user to update data packages without the risk of another user concurrently updating, modifying, or otherwise changing the dataset and leading to a condition that needs a resolution. Permissions for pausing updates may be set by the particular user ID and may also be limited to a particular amount of time for the pause or may be limited by other parameters as set by the implementation of the shared data pool and the permissions established. It should be appreciated that certain implementations of the server may also notify other users of the update pause to prevent duplication of work or other conflicts on the shared data pool network.

When a user wishes to update his or her local copy of the shared data pool dataset, the user may first request the list of available data packages from the server. The system may then compare the list of available data packages provided by the server to the list of data packages on the local dataset. This check of the data packages, and other mediation and monitoring of data package exchange, may normally be carried out on the user's local computer. However, it should be appreciated that in certain embodiments, the system may be set up in such a way that the central server may perform this check. Furthermore, when the user's local computer is utilized to compare the list of available data packages provided by the server to the list of data packages on the local dataset, the software may be integrated with or provided with the shared data pool system, or the software may be other commercially available software that may interface with the system.

After the comparison of the server based and local datasets, if there is a data package on the server that is not present in the local dataset, the system may then download the missing data packages and add it to the local dataset. If there exists a data package on the local dataset that is not present on the server dataset, then the system may delete those local data packages from the local copy of the data pool. In the case that a data package is present on both the server and the local copy of the data pool, but the checksums do not match, then the system may update the local copy of that data package with the server version of the data package. This ensures that the user has a complete, up-to-date dataset without the requirement of having to compare all the data or download the entire dataset prior to use.

Even though the shared data pool may prevent any conflicts of data or concurrent updating by different users, there still may exist periodic inconsistencies in the dataset within the shared data pool. The use of standard packages and locking packages, which maintain the record of changes to the dataset, allows the system to identify and rectify any inconsistencies or conflicts.

For example, the system may verify that a locking package chain is valid when the locking class checksum of the last locking package in the locking package chain is valid, or where the change history provides the correct checksums for all locking class packages in the chain. This evaluation may be made after a break in the locking package chain to verify the validity of that chain. It should be appreciated that a chain may be forked or broken and still qualify as valid. The evaluation of a valid chain allows a user to verify the integrity of the data in the shared data pool. In certain embodiments, it may be possible for one user to update the locking class while another user has validated the locking class data. However, this will be resolved during the next query of the repository of data packages.

Concurrent editing by multiple users of a single locking class may cause multiple updates and a forked locking package chain. The local machine may identify a forked locking package chain when a single locking package ID or message ID is cited or listed as the parent of more than one subsequent locking package. Once a forked chain has been identified, the local machine may then check the validity of the chain by determining whether multiple users have edited the same specific standard packages at the same time. It should be appreciated that this determination of a forked locking package chain may be done on a local machine or, depending on the particular implementation of the data pool, may be detected by a server or centralized computer that may notify users of the forked locking package chain.

Once the forked chain is detected, the system may then evaluate all the packages cited by the forked blocks and all of the child blocks within that forked locking package chain. If all the cited packages match the local checksums of the cited packages, then the data may be verified. The system may then create a new locking package to merge the forked chains by listing all of the terminal locking packages of the forked chains as the previous locking package ID or previous message ID. This merged locking package then may include all the packages evaluated from the forks in the change history. In the case that one forked locking package chain is missed or not recognized by the system or a user, the system may then use the package ID of the partially merged locking package chain and any unmerged chains as described above to merge the additional forked locking package chains.

The system may alco encounter and identify an aborted chain caused by one user uploading while another user concurrently queries the repository for a listing of available packages. The system may identify this when a chain does not include a locking package that should be included in the locking class. In this case, a user may be prompted to wait and query the system a short time later to acquire the missing locking package, to create a new locking package and add it to the chain to resolve the issue, or to ignore the locking package and not load it and any associated data packages into the local dataset.

The system may also identify a broken locking package chain by identifying a missing locking package when one locking package cites to a locking package ID that does not exist in the local dataset. To resolve this conflict, the system may verify that all packages have been downloaded from the shared data pool server. The system may also evaluate all the packages cited in the locking package chain prior to the break. If all locking packages in the locking package chain are accounted for, then the system may create a new locking package to resolve the break. It should be appreciated that a break may be caused by an unauthorized user adding a locking package and this may be used to identify an issue with the shared data pool, the security of the shared data pool, or the permission given to the shared data pool users.

In certain embodiments, the system may attempt to resolve any of these conflicts based on rules that were established during the implementation of the system and set by one or more users of the system. For example, the system may be set to prioritize updates made by certain users or groups of users relative to other users or groups of users. The system may also be set or programmed to track the timestamps of changes to the dataset and to prefer the use of updates which were made later in time. The system may also evaluate the data in question to determine if the changes may be merged or if one of the conflicting changes has higher priority. In certain embodiments, the system may also discard both changes or revert to an earlier version of the data prior to the conflicting changes.

Finally, the system may also be manually reset by a super user or other class of user who has permissions to edit, update, or delete locking packages. In certain cases, a user may elect to reset a locking package chain by deleting all or a portion of the locking package chain and create a new locking package that identifies all packages within the locking class. This manual reset may be used to rectify any issues in the shared data pool or the chain of locking packages that is used to verify the data and track changes to the data over time.

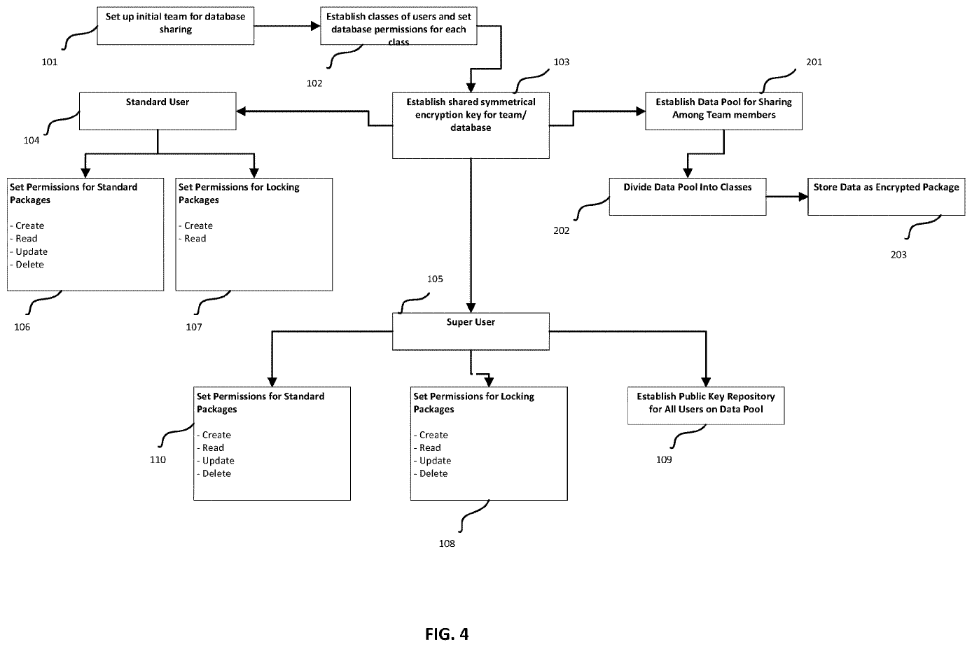

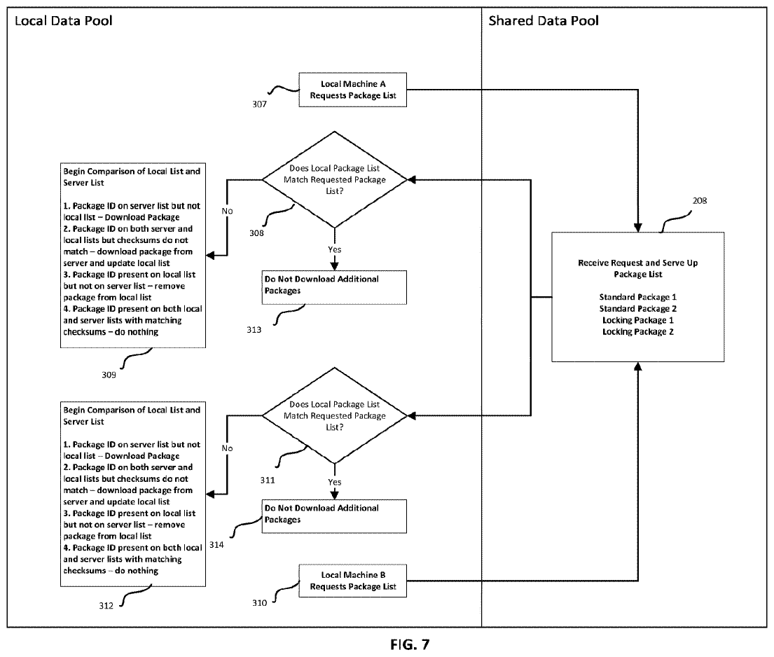

FIGS. 4-7 provide flow diagrams of the secured data pool for use by multiple users. The secured data pool system may be considered as having parallel and concurrently running logic flows that correspond to a user's local machine and the shared data pool server or servers.

Referring to FIG. 4, the shared data pool is first initiated by setting up of an initial team which will use the shared data pool in item 101. A user, typically someone who will have administrative access or who will become a super user of the system (described below) will establish a list of users, which defines a team, establish a list of classes, and determine which users fall into which classes, and then set permission for those classes in item 102. A shared symmetrical encryption key will then be set for use by the team for the database or data pool in item 103. Once the shared symmetrical encryption key is set, a shared data pool may be established in item 201. That shared data pool data may then be divided into classes or categories of data which may correspond or be logically related in some way in item 202, and then the data within a class may be further divided and stored in encrypted packages in item 203. It should be appreciated that the data pool may be divided into any number of classes or categories of data and those classes or categories of data may be defined in any number of ways by the team or users. For example, data may be divided by all files which have a file name starting with a particular letter or number. Data may also be divided based on date of file creation, the type of data or type of file (word processing documents, spreadsheets, images or video files, etc.), or any other parameter as desired or required for a particular workflow. The data as stored is located in standard packages, the permissions for which are established in the setup of the shared data pool. It should be appreciated that these classes or categories of data may then be tracked by locking packages which are associated with that class or category of data. The locking package may include this information in the locking class 36 field as shown with reference to FIG. 3 above.

Still referring to FIG. 4, the users on the team may be divided into one or more classes, each of which may have access to different types of packages and may have different permission for each set of packages. As shown, the users may be divided into standard users in item 104 and super users in item 105. An exemplary set of permissions are also shown in FIG. 4. For example, a standard user may be given permission to create, read, update, and delete standard data packages as shown in item 106. The standard user may then also be given permission to create and read locking packages in item 107. A super user may also be given permission to create, read, update, and delete standard packages in item 110. However, the super user may also be given permissions to create, read, update, and delete locking packages in item 108. During the setup of the shared data pool, a repository of public encryption keys for asymmetric encryption for every user of the shared data pool may be established and maintained on the central data server in item 109.

It should be appreciated that the shared data pool may be set up with any arbitrarily defined set of users for a team, and any arbitrarily defined division of those users. As shown, the team may be set up to allow for two classes of users, standard users and super users. All team members may then be given full permission to create, read, update, and delete the shared data that is stored in the standard packages of the shared data pool. All the users may also be given permission to create and read locking packages, which are used to monitor changes to data and ensure data integrity on the shared data pool. However, super users may also be given permission to update and delete locking packages, which is not granted to the standard users of the shared data pool. The shared data pool may also function with more classes of users, and the permission granted to those users may be varied as necessary for a particular workflow or implementation of the shared data pool. These permissions may not only define how or what modifications may be made to particular standard packages or locking packages, but may also include what users on the system have access to certain classes or subsets of standard packages and locking packages. For example, one user may be allowed access to all of the data stored on the shared data pool while another user may only be allowed access to a certain subset of data that is pertinent to that particular user's role within the team.

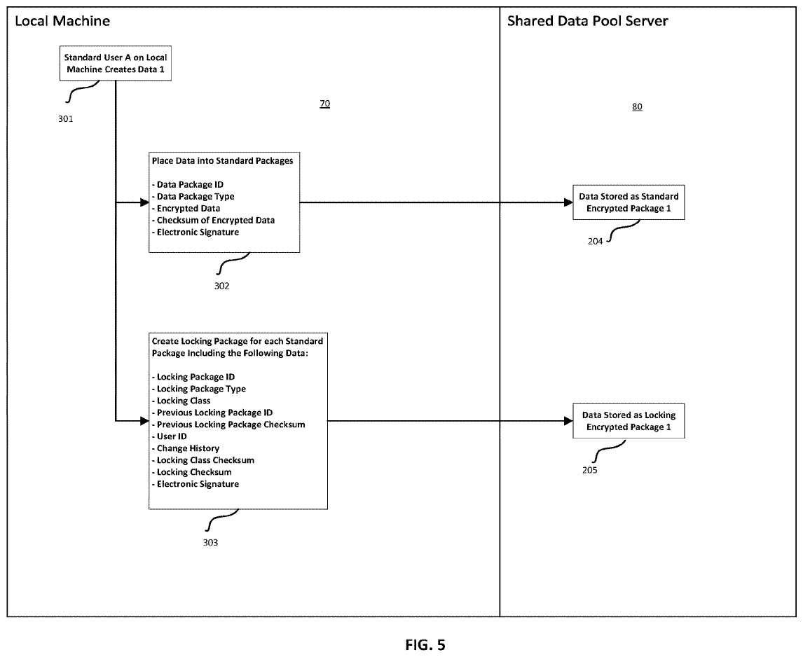

FIG. 5 provides a flow chart of the creation of data by a local machine 70 of the shared data pool and how that data is recorded on the shared data pool server 80. A first standard user (user A) may create a local copy of data in item 301. This data may then be placed into one or more standard packages in item 302. Within each standard package may be a package ID giving a unique identifier to this data package on the shared data pool, the package type (in this case a standard data package), the encrypted data created by user A on the local machine 70, and a checksum of all the data contained within this data package, standard package 1. The standard package 1 which is generated on the local machine 70 at 302 may also include an optional electronic signature to verify the user which created the standard package or data. Simultaneously, a locking package (locking package 1) will be created that corresponds to all the changes made by user A on local machine 70 in item 303 to data held within all data packages associated with the classification or category of data which the locking package tracks. Each locking package may include data including a unique locking package ID, the type of package (here a locking package), the locking class of the locking package that defines the type or category of data tracked by the locking package, the ID of the previous locking package in the chain, the checksum of the previous locking package in the chain, the user ID of who created the locking package, the change history which represents all the standard package IDs and their checksums for the standard packages that triggered the generation of this locking package, the checksum for the entire locking class, the checksum for the locking package, and an optional electronic signature of the user that caused the generation of the locking package on the local machine 70.

Once the local machine has created standard package 1 and locking package 1, these packages may be sent to the shared data pool server 80. For instance, the data stored in standard package 1 may be sent to the shared data pool server 80 for the shared data pool in item 204 and the history of changes made to the data that is recorded in locking package 1 may be sent to the shared data pool server 80 for the shared data pool in item 205. The shared data pool system has now been updated with the new data created by user A on the local machine 70, and copies exist both on the local machine 70 with user A and in the central server 80 of the shared data pool. The central server 80 may then add the new data created by user A on local machine 70 to the registry or list of all data packages that is contained on the shared data pool.

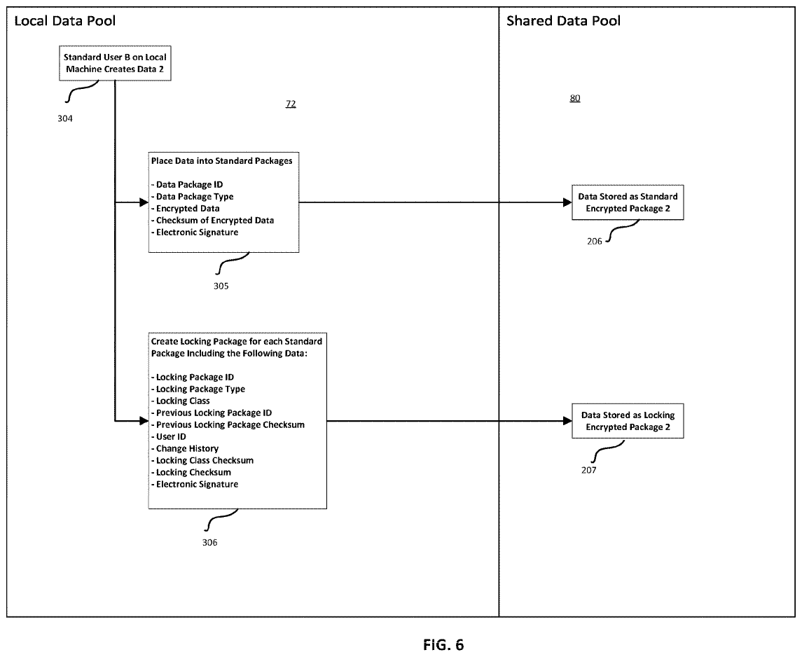

FIG. 6 provides a flow chart showing a second standard user on a local machine 72 creating additional data that is to be shared through the secure, shared data pool. A second user, user B, may create new data, data 2, on his or her local machine 72 in item 304. The local machine 72 may then take and package data 2 into one or more standard data packages (standard package 2) with the information and fields (as described above) in item 305. Once again, a locking package (locking package 2) corresponding to each standard package is created by the local machine 72 with information recording the change history of the data stored in the one or more standard data packages for data 2 in item 306. The local machine 72 may then upload standard package 2 to the central server 80 where it is stored in item 206 and upload the corresponding locking package 2 to the central server 80 where it is stored in item 207. There will now be a local copy of standard package 2 on local machine 72, and a copy of standard package 2 on the central server 80 of the shared data pool. The central server 80 may then add the new data created by user B on local machine 72 to the registry or list of all data that is contained on the shared data pool.

FIG. 6 provides a flow chart showing how data is distributed across the shared data pool when requested by one or more users. For example, user A on local machine A may request a package list from the central server of all the standard data package IDs that are currently on the shared data pool in item 307. The central server may then provide this listing of standard package IDs to user A in item 208. Local machine A may then query whether the local package list of standard package IDs and locking package IDs matches the requested package list that was provided by the shared data pool serve in item 308. If the local package list matches the requested package list, then the local machine should not request the download of any additional packages at item 313. However, if the local package list does not match the requested package list, the local machine may then attempt to reconcile the local package list with the package list received from the shared data pool server at 309.

Local machine A may proceed through a check of the list of local data packages against the list provided by the shared data pool server. For each possible outcome of comparison between the local list of data packages and the list of data packages provided by the shared data pool server, there is a defined response by local machine A to reconcile both the local and shared data pools. For example, if a package ID exist on the server list but not on the local list, then local machine A may request and download that package from the shared data pool server. If, however, a package ID exists both on the local and shared data pool server lists, but the checksums for that package ID do not match, the local machine should download the current version of the package from the shared data pool server and update the local list of data packages. If a package ID is present on the local list but not on the server list, the local machine should remove the data package from local data pool as it is expired or obsolete data. Finally, if a package ID is present on both the local data pool list and the shared data pool list and the checksums for that package ID match, the local machine should do nothing as it has the current version of that data package.

With reference to the exemplary method outlined with reference to FIGS. 5-7, local machine A 70 may check the list of standard data package IDs provided by the shared data pool server 80 against the local list of standard data package IDs. Local machine A 70 will be able to determine that it does not have the full set of data stored on the central server because the package ID for standard package 2 that was uploaded by local machine B 72 will not be in local machine A 70 local data set, and the checksums for the local machine A 70 local data set will not match the checksums for the central server 80 data set. Local machine A 70 may then download the missing standard data package 2 in to have the full data set that is present on the central server 80 for the shared data pool.

Similarly, local machine B 72 may also request the package list from the central server 80 in item 310. As before, the central server 80 may send the listing of package IDs and checksums to local machine B 72 in item 208. Local machine B 72 may then check the listing of package IDs and checksums provided by the central server 80 against the package IDs and checksums of the local machine B 72 local dataset in item 311. If the local machine B 72 listing of package IDs and checksums matches the listing of package IDs and checksums provided by the shared data pool server 80, then the local machine B 72 may do nothing at item 314. However, if there are discrepancies between the local machine B 72 listing of package IDs and the listing of package IDs provided by the central server 80, then local machine B 72 may carry out a comparison of the local list of package IDs and the central server 80 list of package IDs at item 312 as described above with reference to local machine A 70.

Still referencing the current exemplary process, during this process, local machine B 72 will be able to determine that it is not in possession of the data previously uploaded by local machine A 72 in standard package 1 and may then request the central server 80 to serve up the missing packages in item 312.

Still referring to FIG. 4, it should be appreciated that a local machine 70, 72 may use both the listing of package IDs and the checksums of those packages individually and the checksums of the entire class or category of packages to determine whether or not the local dataset is equivalent to the data set on the central server 80 for the shared data pool. The provision for the listing of package IDs allows a local machine 70, 72 to determine if a package is missing from the local dataset. The provision of the checksums that are recorded in the locking packages also allows a local machine 70, 72 to determine if, even if they are in possession of all the package IDs on the shared data pool, any of the standard data packages have been updated or changed without having to download and compare the actual data of those standard packages. Rather, the local machine 70, 72 may determine that the checksums have changed and then request those packages be downloaded from the shared data pool and updated on the local copy of the dataset.

In summary, while the present invention has been described with respect to specific embodiments, many modifications, variations, alterations, substitutions, and equivalents will be apparent to those skilled in the art. The present invention is not to be limited in scope by any of the specific embodiments described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

It should be appreciated that any element, part, section, subsection, or component described with reference to any specific embodiment above may be incorporated with, integrated into, or otherwise adapted for use with any other embodiment described herein unless specifically noted otherwise or if it should render the embodiment device non-functional. Likewise, any step described with reference to a particular method or process may be integrated, incorporated, or otherwise combined with other methods or processes described herein unless specifically stated otherwise or if it should render the embodiment method nonfunctional. Furthermore, multiple embodiment devices or embodiment methods may be combined, incorporated, or otherwise integrated into one another to construct or develop further embodiments of the invention described herein.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particular interrelationship of such elements. Accordingly, the descriptions and drawings are to regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

I claim:

1. An encrypted multiple user database system comprising:
at least one local machine in communication with at least one server;
wherein said at least one server receives a list of users, said list of users divided into at least two classes of user, wherein each of said at least two classes of users receive different permission for accessing said multiple user database system, wherein said at least one server establishes a data pool containing electronic data, said electronic data divided into one or more data classes and wherein said at least one server defines a first data package type and a second data package type;
said first data package type comprising a standard package type and said second data package type comprising a locking package type; and
wherein said standard package type stores said electronic data and said locking package type stores information relating to one or more changes made to said standard package type.

2. A method of database management comprising:
receiving a list of users;
dividing said list of users into at a first class of users and a second class of users;
assigning a first type of database permission to said first class of users and assigning a second type of database permission to said second class of users;
establishing a data pool for sharing among said list of users;
dividing data contained within said data pool into one or more standard data packages;
generating at least one locking package upon a change to one or more of said one or more standard data packages;
maintaining a list of said one or more standard data packages and maintaining a list of said at least one locking package.

3. At least one computer-readable storage medium having instructions recorded thereon which, when executed by a computer, cause the computer to perform a method for operating a multiple user database, the method comprising:
receiving a list of users;
dividing said list of users into at a first class of users and a second class of users;
assigning a first type of database permission to said first class of users and assigning a second type of database permission to said second class of users;
establishing a data pool for sharing among said list of users;
dividing data contained within said data pool into one or more standard data packages;
generating at least one locking package upon a change to one or more of said one or more standard data packages;
maintaining a list of said one or more standard data packages and maintaining list of said at least one locking package.
